(19) United States
(12) Patent Application Publication
(10) Pub. No.: US 2011/0249356 A1
(43) Pub. Date: Oct. 13, 2011

(54) DISK STORAGE APPARATUS AND METHOD FOR RECORDING DATA

(75) Inventor: Takashi MATSUO, Hasuda-shi (JP)

(73) Assignee: Kabushiki Kaisha Toshiba, Tokyo (JP)

(21) Appl. No.: 13/008,744

(22) Filed: Jan. 18, 2011

(30) Foreign Application Priority Data
Apr. 12, 2010 (JP) 2010-091550

(51) Int. Cl. G11B 20/18

(52) U.S. Cl. 360/39; G9B/20.046

(57) ABSTRACT

According to one embodiment, a disk storage apparatus includes a data recording module and a controller. The data recording module is configured to record a first sync mark and a second sync mark in each data sector provided on a disk. The controller is configured to control the data recording module, causing the data recording module to omit recording the second sync mark in one of segments into which the data sector is split.

### CROSS-REFERENCE TO RELATED APPLICATIONS

This application is based upon and claims the benefit of priority from Japanese Patent Application No. 2010-091550, filed Apr. 12, 2010; the entire contents of which are incorporated herein by reference.

### FIELD

Embodiments described herein relate generally to a disk storage apparatus of the dual sync-mark system.

### BACKGROUND

Most disk storage apparatuses (hereinafter referred to as “disk drives”), a representative example of which is a hard disk drive, magnetically records user data on a disc, in units of data sectors. As the data is so recorded, sync marks are recorded in the data sectors, each used to detect the head of a user data item. That is, a sync mark is recorded in the head part of each data sector, and a user data item is recorded at the tail of the sync mark.

While data is being reproduced from the disk, a sync mark cannot be detected if a defect exists in or near that part of the data sector, in which the sync-mark is recorded. In this case, the data item cannot be read from the data sector.

In view of this, it is proposed that the dual sync-mark system should be used. In the dual sync-mark system, first and second sync marks are recorded in each data sector and spaced apart from by a prescribed distance. (See, for example, Japanese Patent No. 3300628.) If this system is used, the second sync mark may be detected even if the first sync mark cannot be detected. The data can therefore be read from the data sector.

The disk drives developed in recent years adopt the zone-bit recording system that renders the recording density uniform on the disk. In this scheme, the disk has servo areas (i.e., servo-data recording areas), which splits some data sectors, each into segments.

If the dual sync-mark system is applied a data sector split into segments, the first and second sync marks are recorded in each segment. The segment inevitably needs to have a length greater than or equal to a particular data length. Hence, any data sector of the disk cannot be split into segments having a length less than or equal to the particular length. In other words, the data length of each segment is greatly limited, ultimately decreasing the efficiency of data-formatting that forms data sectors on the disk.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram explaining the configuration of a disk drive according to an embodiment;

FIG. 2 is a diagram explaining the basic configuration of a data sector according to the embodiment;

FIG. 3 is a diagram explaining how each data sector is split in the embodiment;

FIG. 4 is a diagram explaining data reproduced in the embodiment;

FIG. 5 is a flowchart explaining how data is reproduced in the embodiment; and

FIG. 6 is a flowchart explaining how data is reproduced in another embodiment.

### DETAILED DESCRIPTION

Various embodiments will be described hereinafter with reference to the accompanying drawings.

In general, according to one embodiment, a disk storage apparatus includes a data recording module and a controller. The data recording module is configured to record a first sync mark and a second sync mark in each data sector provided on a disk. The controller is configured to control the data recording module, causing the data recording module to omit recording the second sync mark in one of segments into which the data sector is split.

[Configuration of the Disk Drive]

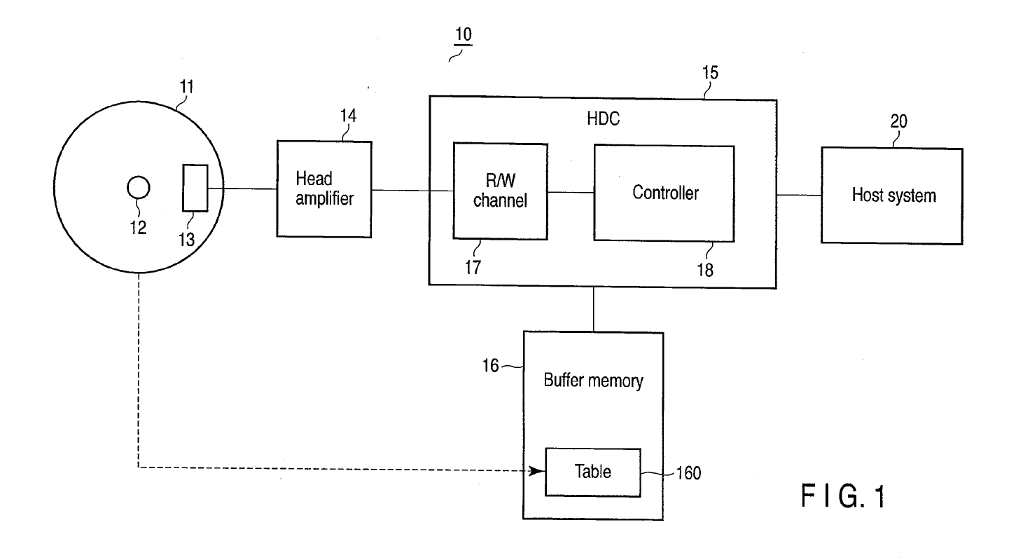

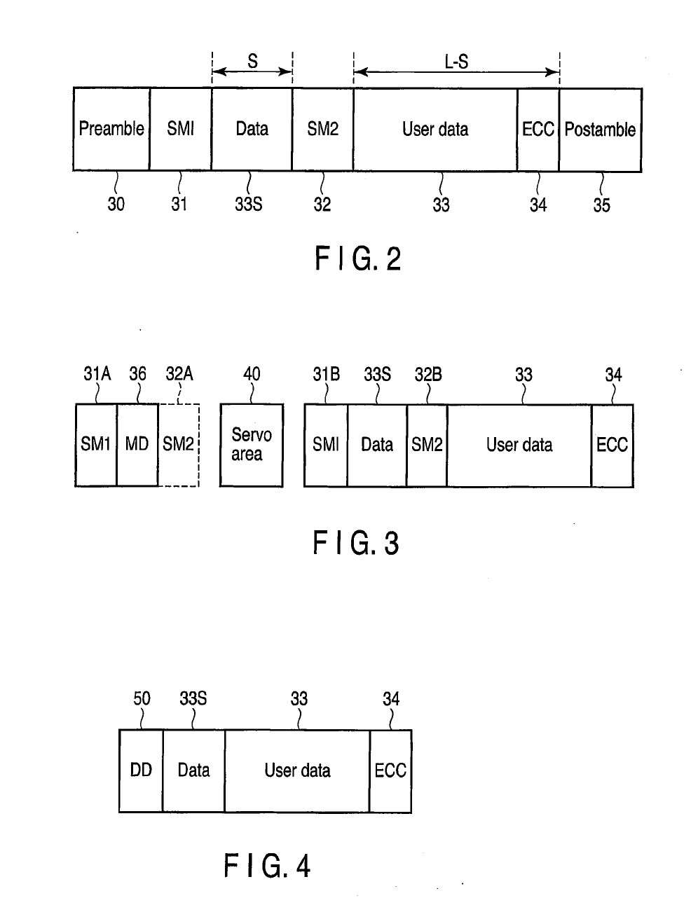

FIG. 1 is a block diagram explaining the configuration of a disk drive according to an embodiment. FIG. 2 is a diagram explaining the basic configuration of a data sector according to the embodiment.

As shown in FIG. 1, the disk drive 10 has a disk 11, a spindle motor 12, a head 13, a head amplifier 14, a hard disk controller (HDC, or disk controller) 15, and a buffer memory 16. The disk 11 is a magnetic recording medium. The spindle motor 12 rotates the disk 11. The head 13 includes a read head element and a write head element, and is configured to read and write data from and on the disk 11.

The head amplifier 14 receives a signal (read data) read by the head 13 and amplifies the signal, which is transmitted to the disk controller 15. The head amplifier 14 also receives a signal (write data) output from the disk controller 15 and converts this signal into a current, which is supplied to the head 13.

The disk controller 15 includes a read/write (R/W) channel 17 and a controller 18. The R/W channel 17 is a circuit configured to process signals to be recorded on the disk 11 and signals reproduced from the disk 11. More precisely, the R/W channel 17 has the function of decoding the data the head 13 has read and encoding the data the head 13 will write. The controller 18 is an interface that uses the buffer memory 16, controlling the data transfer between the R/W channel 17 and a host system 20. The controller 18 controls the recording and reproduction of data through the R/W channel 17, to detect sync marks and recover data in this embodiment.

When controlled by the controller 18, the buffer memory 16 temporarily stores read/write data in the buffer memory 16. The buffer memory 16 also stores a format data table 160 about data sectors, read from the system area provided on the disk 11. The host system 20 is a digital apparatus such as a personal computer or a digital TV receiver that uses the disk drive 10 as an external storage device.

[Recording and Reproduction of Data]

How the disk drive 10 according to this embodiment records and reproduce data will be explained with reference to FIG. 2 to FIG. 6.

The disk drive 10 according to this embodiment uses the dual sync-mark system in order to record user data on the disk 11 as shown in FIG. 2.

FIG. 2 is a diagram explaining the configuration of a data sector which is a data access unit. In FIG. 2, L is the length of the data sector, and S is the length of a part 33S of user data 33. In the data sector, user data 33 and an error correction code (ECC) 34 are recorded. The part 33S of user data 33 is recorded between a first sync mark (SM1) 31 and a second sync mark (SM2) 32.

To record data via the R/W channel 17, the controller 18 performs a control, thereby recording the preamble 30, first sync mark 31, user data part 33S, second sync mark 32, user data 33, ECC 34 and postamble 35 in the data sector, in the order mentioned, from the head of the data sector. The postamble 35 is thus recoded at the tail of the data sector.

To reproduce data via the R/W channel 17, the controller 18 reproduces the part 33S of the user data 33 and the user data 33 from the read data read by the head 13, as the first sync mark 31 is detected. If the first sync mark 31 is not detected, the controller 18 will reproduce the user data 33 from the read data read by the head 13, as the second sync mark 32 is detected.

In the disk drive 10 using the zone-bit recording system, the disk 11 has a zone, in which a servo area 40 splits a data sector into two segments as shown in FIG. 3. The servo area 40 is a recording area that holds servo data, which is used to achieve servo control, or controls the positioning of the head 13. The controller 18 refers to the format data table 160 about the data sector, which has been read from the system area of the disk 11 and stored in the buffer memory 16. The controller 18 thereby recognizes the configuration of the data sector split by the servo area 40.

How data is recorded in the data sector thus split in the dual sync-mark system will be explained with reference to FIG. 3. Note that the preamble 30 and the postamble 35 are not illustrated in FIG. 3, for the sake of convenience.

As shown in FIG. 3, the servo area 40 splits data sector into a first segment and a second segment. Assume that the first segment is a recording area less than or equal to a prescribed data length. The controller 18 performs a control, whereby the first sync mark (SM1) 31A is recorded at the head of the first segment, and data (MD) 36 having a minimum symbol length equivalent to a part of the user data is recorded next to the first sync mark 31A.

The controller 18 omits recording the second sync mark (SM2) 32A. This is because the first segment is a recording area less than or equal to a prescribed data length. If the first segment is greater than the prescribed data length, the controller 18 may control the R/W channel 17 to record the second sync mark (SM2) 32A.

Further, the controller 18 performs a controls, recording the first sync mark (SM1) 31B at the head of the second segment, and recording the part 33S of user data, second sync mark 32, user data 33 and ECC 34, after the first sync mark 31B.

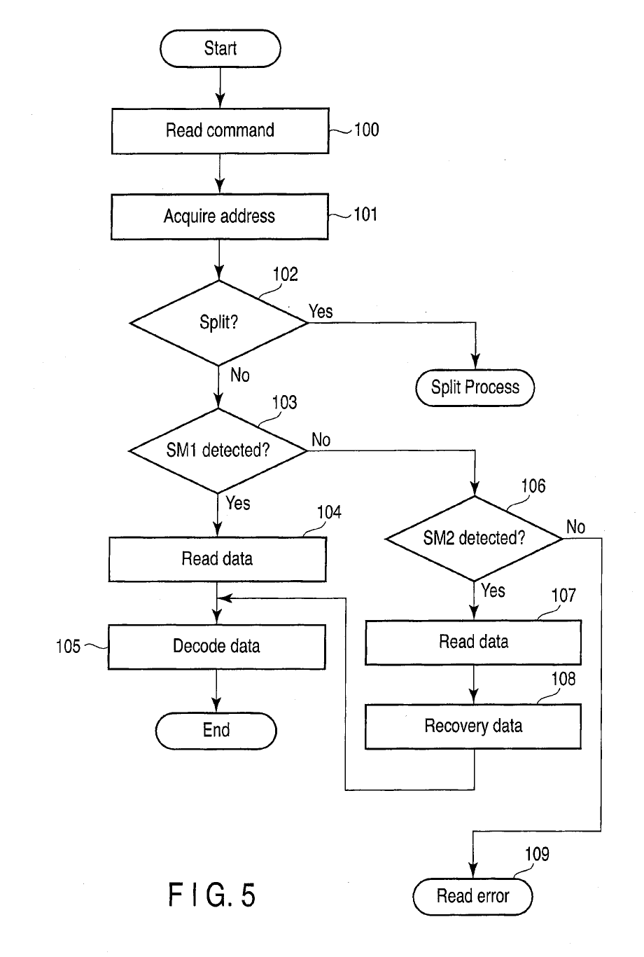

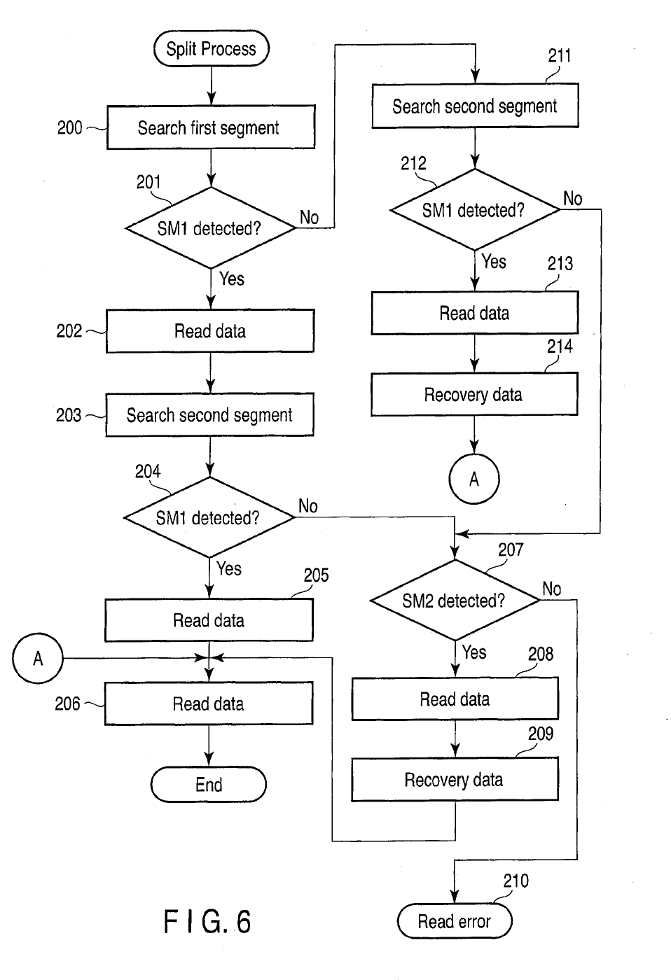

How data is reproduced in the dual sync-mark system will now be explained with reference to the flowchart of FIG. 5 and the flowchart of FIG. 6. First, how data is reproduced from an ordinary data sector shown in FIG. 2 will be explained.

On receiving a read command from the host system 20, the controller 18 starts reproducing data via the R/W channel 17 (Block 100). In accordance with the logical address contained in the read command, the controller 18 acquires the address of the data sector that should be accessed to read the data (Block 101).

The controller 18 then refers to the format data table 160 and determining whether the data sector to be accessed is a split one (Block 102). If the data sector is a split one (YES in Block 102), data will be reproduced from the data sector, as will be described later with reference to the flowchart of FIG. 6.

If the first sync mark 31 is detected in the data sector shown in FIG. 2 (YES in Block 103), the controller 18 reproduces, via the R/W channel 17, the part 33S of user data and the user data 33 that follow the first sync mark 31 (Block 104). The controller 18 then decodes the write data from the part 33S of user data and the user data 33 (Block 105).

If the first sync mark 31 is not detected (NO in Block 103), the controller 18 determines whether the second sync mark 32 is detected (Block 106). If the second sync mark 32 is detected (YES in Block 106), the controller 18 reproduces the user data 33 (Block 107). In this case, the part 33S of user data is not reproduced, the controller 18 uses dummy data (DD) having a symbol length of the part 33S, recovering the recorded data composed of the user data 33 and ECC 34 (Block 108).

The second sync mark 32 may not be detected, either (NO in Block 106). In this case, the controller 18 finds that data cannot be reproduced from the data sector, and performs a read-retry process (Block 109). More specifically, the controller 18 performs the read-retry process as read-error process.

How data is reproduced from such a split data sector as shown in FIG. 3 will be explained with reference to the flowchart of FIG. 6.

The controller 18 detects the first sync mark 31A from the first segment of the data sector (Block 200). As the first sync mark 31A is detected (YES in Block 201), the controller 18 reproduces the data (MD) 36 having a minimum symbol length (Block 202). Next, the controller 18 detects the first sync mark 31B is detected from the second segment (Block 203).

The controller 18 determines whether the first sync mark 31B is detected from the second segment (Block 204). If the first sync mark 31B is detected (YES in Block 204), the controller 18 reproduces the part 33S of user data and the user data 33 (Block 205). Then, the controller 18 decodes the write data from the part 33S of user data and the user data 33 (Block 206).

If the first sync mark 31A cannot be detected from the first segment (NO in Block 201), the second sync mark 32A does not exist in the second segment as shown in FIG. 3. Hence, the controller 18 goes to the process of reproducing the second segment (block 211). That is, as the first sync mark 31B is detected (YES in Block 212), the controller 18 reproduces the part 33S of user data and the user data 33 (Block 213).

In Block 213, the controller 18 cannot reproduce the data (MD) 36 having a minimum symbol length. Therefore, the controller 18 uses dummy data (DD) 50 having a symbol length of the data 36, thereby recovering the data (Block 214). More precisely, the controller 18 recovers data composed of the dummy data (DD) 50, part 33S of user data and ECC 34 as shown in FIG. 4 (Block 108). The dummy data (DD) 50 has a minimum symbol length “0.”

The controller 18 reproduces the user data as the second sync mark 32B is detected (Block 208), if the first sync mark 31A is no detected from the first segment (NO in Block 204) and if the first sync mark 31B is detected from the second segment (YES in Block 207). At this point, the controller 18 cannot reproduce the part 33S of user data. Therefore, the controller 18 uses the dummy data having the symbol length of the part 33S, thereby recovering recorded data composed of the data (MD) 36 of minimum symbol length, user data 33 and ECC 34 (Block 209).

The second sync mark 32B may not be detected from the second segment, (NO in Block 207). In this case, the controller 18 finds that data cannot be reproduced from the data sector, and performs a read-retry process, i.e., read-error process (Block 210).

As has been described, if an area 40 splits a data sector into two segments on the disk 11 in the dual sync-mark system, only the first sync mark 31A is recorded in the first segment, not recording the second sync mark 32A, in the disk drive 10 according to this embodiment. Therefore, a split configuration is achieved even if the first segment defines a small recording area having a data length of less than or equal to S+M, where M is the data length equivalent to the minimum symbol length of the data (MD) 36. Hence, the data length of the first segment only needs to be the minimum symbol length. This mitigates the data length limited in any split data sector. In other words, the minimum data length of either segment of the data sector can be less restricted, ultimately increasing the efficiency of data-formatting that forms data sectors on the disk.

From the first segment of any data sector, data may not be read because a defect exists in, for example, the first sync mark 31A. In this case, dummy data (DD) of minimum symbol length is used in place of data MD of minimum symbol length, thereby recovering the data. As a result, data can be reproduced from the data sector.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk storage apparatus comprising:
a data recording module configured to record a first sync mark and a second sync mark in a data sector provided on a disk; and
a controller configured to control the data recording module, causing the data recording module to omit recording the second sync mark in one of segments into which the data sector is split.

2. The disk storage apparatus of claim 1, further comprising a data reproduction module configured to reproduce data from the data sector split into segments,
wherein the controller controls the data reproduction module, causing the data reproduction module to reproduce the data by using prescribed dummy data, if the first sync mark cannot be detected from the segment that the second sync mark is omitted.

3. The disk storage apparatus of claim 1, wherein the controller is configured to perform a prescribed error process if the first sync mark is not detected from the segment that the second sync mark is omitted and if neither the first sync mark nor the second sync mark is detected from the other segment.

4. The disk storage apparatus of claim 1, further comprising a data reproduction module configured to reproduce data from the data sector split into segments,
wherein the controller controls the data reproduction module, causing the data reproduction module to reproduce the data by using data and prescribed dummy data reproduced from the other segment, if the first sync mark cannot be detected from the segment that the second sync mark is omitted.

5. A disk control apparatus comprising:
a data recording module configured to record a first sync mark and a second sync mark in a data sector provided on a disk; and
a controller configured to control the data recording module, causing the data recording module to omit recording the second sync mark in one of segments into which the data sector is split.

6. The disk control apparatus of claim 5, further comprising a data reproduction module configured to reproduce data from the data sector split into segments,
wherein the controller controls the data reproduction module, causing the data reproduction module to reproduce the data by using prescribed dummy data, if the first sync mark cannot be detected from the segment that the second sync mark is omitted.

7. The disk control apparatus of claim 5, wherein the controller is configured to perform a prescribed error process if the first sync mark is not detected from the segment that the second sync mark is omitted and if neither the first sync mark nor the second sync mark is detected from the other segment.

8. The disk control apparatus of claim 5, further comprising a data reproduction module configured to reproduce data from the data sector split into segments,
wherein the controller controls the data reproduction module, causing the data reproduction module to reproduce the data by using data and prescribed dummy data reproduced from the other segment, if the first sync mark cannot be detected from the segment that the second sync mark is omitted.

9. A method of recording and reproducing data, for use in a disk storage apparatus designed to record first and second sync marks and data on a disk, the method comprising:
recording data in a data sector split into a plurality of segments;
recording the first sync mark and omitting the second sync mark, in a first segment; and
recording the first sync mark and the second sync mark in a second segment.

10. The method of claim 9, further comprising:
reproducing data from the data sector split into segments; and
reproducing the data by using prescribed dummy data, if the first sync mark cannot be detected from the first segment.

11. The method of claim 9, further comprising:
reproducing data from the data sector split into segments; and
producing data by using data and prescribed dummy data reproduced from the second segment, if the first sync mark cannot be detected from the first segment.

12. The method of claim 9, further comprising:
reproducing data from the data sector split into segments; and
performing a prescribed error process if the first sync mark is not detected from the first segment and if neither the first sync mark nor the second sync mark is detected from the second segment.
